(19) United States
(12) Patent Application Publication
(10) Pub. No.: US 2007/0240595 A1
(43) Pub. Date: Oct. 18, 2007

(54) Method and apparatus for metering printing fluid, printing press and system having the apparatus and method for driving a pump

(75) Inventor: Michael Nagel, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/787,948

(22) Filed: Apr. 18, 2007

(30) Foreign Application Priority Data
Apr. 18, 2006 (DE) 10 2006 017 918.8

(51) Int. Cl. B41F 31/02

(52) U.S. Cl. 101/366

(57) ABSTRACT

A method and an apparatus for metering a printing fluid include a pump driven by the printing fluid. The printing fluid can be printing ink or varnish. A printing press and a system having the apparatus as well as a method for driving a pump, are also provided.

### CROSS-REFERENCE TO RELATED APPLICATION

This application claims the priority, under 35 U.S.C. §119, of German Patent Application DE 10 2006 017 918.8, filed Apr. 18, 2006; the prior application is herewith incorporated by reference in its entirety.

### BACKGROUND OF THE INVENTION

### Field of the Invention

The present invention relates to a method and an apparatus for metering a printing fluid. The invention also relates to a printing press and a system having the apparatus. The invention moreover relates to a drive method for driving a pump through the use of a drive fluid.

The invention arose against the following background: printing fluids are understood to be coating fluids, with which the printing material is printed, and auxiliary fluids which serve to assist the printing process. Coating fluids are, for example, printing inks and printing varnishes. An auxiliary fluid is, for example, a dampening solution which assists the printing of an offset printing ink. A printing fluid can also be pasty, as is the case, for example, in an offset printing ink.

In printing presses which have a high consumption of the printing fluid, the latter is stored in a storage drum which is situated next to the printing press. The printing fluid is conveyed out of the storage drum to its place of use in the printing press through the use of a delivery device. The delivery device includes a volumetric pump for pumping a defined volume of the printing fluid per unit time, that is to say for metering the printing fluid. For example, in printing presses having varnishing units, a varnish drum is situated next to the varnishing unit. The varnish is pumped from the varnish drum into the varnishing unit through the use of the pump.

German Published, Non-Prosecuted Patent Application DE 26 25 850 A1, corresponding to U.S. Pat. No. 3,987,727, describes a delivery device for delivering printing ink. The delivery device includes a tandem cylinder having two pistons which are connected by a piston rod. One piston is loaded with compressed air which serves as a drive fluid. As a consequence, the other piston presses the printing ink out of an ink can. One unfavorable aspect thereof is the necessity to provide external energy, in that case the compressed air.

German Patent DE 196 32 717 C2, corresponding to U.S. Pat. No. 5,921,181, and German Published, Non-Prosecuted Patent Application DE 199 53 324 A1, form further prior art.

### SUMMARY OF THE INVENTION

It is accordingly an object of the invention to provide a method and an apparatus for metering a printing fluid, a printing press and a system having the apparatus and a method for driving a pump, which overcome the hereinafore-mentioned disadvantages of the heretofore-known methods and apparatuses of this general type.

With the foregoing and other objects in view there is provided, in accordance with the invention, a method for metering a printing fluid. The method comprises providing a pump and driving the pump with the printing fluid.

In accordance with another mode of the invention, the printing fluid is a printing ink or a varnish. In a further development, the pump is a piston pump. In an added development, a metering volume of the printing fluid is determined by a number, which is proportional to the metering volume, of strokes of a piston of the piston pump being counted through the use of a control device. In an additional development, the piston is loaded with the printing fluid through a multiway valve. The multiway valve is controlled by the control device through control signals and the control signals are counted by the control device.

With the objects of the invention in view, there is also provided an apparatus for metering a printing fluid. The apparatus comprises a pump driven by the printing fluid.

In accordance with a further feature of the invention, the printing fluid can also be a printing ink or a varnish, and the pump can be a piston pump. In a further development, the piston pump has a piston and there is a control device for counting a number of strokes of the piston, which number is proportional to a metering volume of the printing fluid. In another development, the piston is loaded with the printing fluid through a multiway valve and the control device is configured for controlling the multiway valve through control signals and for counting the control signals.

With the objects of the invention in view, there is additionally provided a printing press, comprising a metering apparatus according to the invention.

With the objects of the invention in view, there is furthermore provided a system, comprising a first ink fountain, a second ink fountain and a common supply device for supplying the first ink fountain and the second ink fountain with printing fluid. A metering apparatus according to the invention connects the common supply device to the first ink fountain and a further metering apparatus according to the invention connects the common supply device to the second ink fountain.

In accordance with an added feature of the invention, the common supply device includes a storage vessel for storing the printing fluid and a delivery pump for pumping the printing fluid. In another development of the system, the latter includes a first printing press, in which the first ink fountain is disposed, and a second printing press, in which the second ink fountain is disposed.

With the objects of the invention in view, there is concomitantly provided a method for driving a pump. The method comprises driving the pump with a drive fluid and using a printing fluid as the drive fluid.

In accordance with an additional feature of the invention, the pump can be a piston pump and the printing fluid can be a printing ink or a varnish.

Other features which are considered as characteristic for the invention are set forth in the appended claims.

Although the invention is illustrated and described herein as embodied in a method and an apparatus for metering a printing fluid, a printing press and a system having the apparatus and a method for driving a pump, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a system which includes a plurality of printing presses;

FIG. 2 is a schematic and block diagram of a metering apparatus, with which each of the printing presses of FIG. 1 is equipped;

FIG. 3 is a diagrammatic and schematic view of a first exemplary embodiment of a piston pump of the metering apparatus of FIG. 2;

FIG. 4 is a diagrammatic view of a modification of the first exemplary embodiment of FIG. 3; and

FIG. 5 is a diagrammatic and schematic view of a second exemplary embodiment of the piston pump of the metering apparatus of FIG. 2.

### DESCRIPTION OF THE PREFERRED EMBODIMENTS

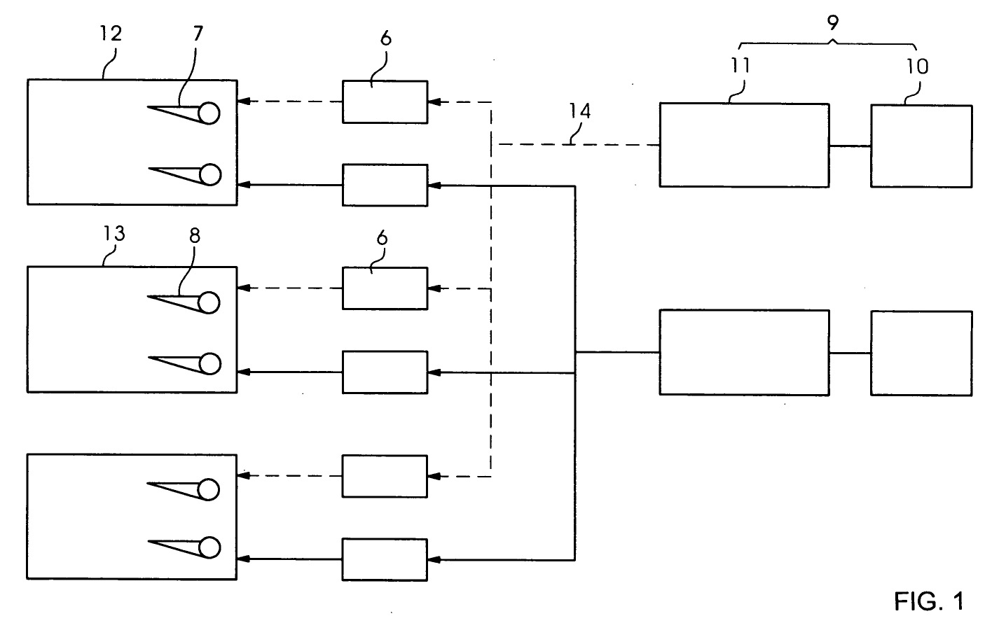

Referring now in detail to the figures of the drawings, in which components and elements that correspond to one another are denoted by the same designations, and first, particularly, to FIG. 1 thereof, there is seen a machine system which includes a first printing press 12 and a second printing press 13. The printing presses 12, 13 are sheet-fed printing presses for offset printing. Each printing press 12, 13 has at least four printing units which include, inter alia, one ink fountain in each case. Reference numeral 7 denotes a first ink fountain of a printing unit of the first printing press 12 and reference numeral 8 denotes a second ink fountain of a printing unit of the second printing press 13.

A metering device 6 is coordinated with the first ink fountain 7 and a metering device 6 of the same type is coordinated with the second ink fountain 8. The metering devices 6 are connected to a storage vessel 10 through a line system 14 with a delivery pump 11. The storage vessel 10 and the delivery pump 11 together form a supply device 9 for supplying the ink fountains 7, 8 with a defined printing ink, for example with the printing ink black. There is a supply device of this type for each of the printing inks black, cyan, magenta and yellow, which are required for four-color printing. FIG. 1 shows only two of these supply devices, by way of example.

The storage vessel 10 is a storage drum, in which the respective printing ink is stored for all of the printing presses 12, 13. The delivery pump 11 pumps the printing ink out of the storage vessel 10 and in the process applies hydraulic pressure to the printing ink in that part of the line system 14 which follows the delivery pump 11. Since the printing ink is printed in the printing presses 12, 13, it is referred to as printing fluid or printing technology fluid 1 in the following text.

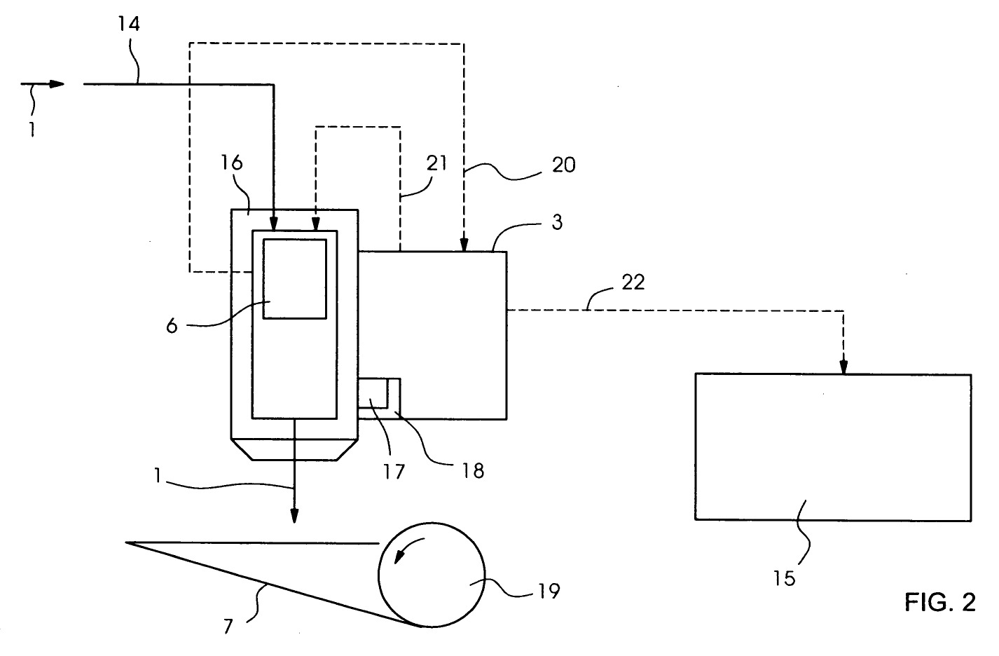

FIG. 2 shows the configuration of the metering apparatuses 6 using the example of the first ink fountain 7 and the metering apparatus 6 which is assigned thereto. The metering apparatus 6 which is shown is held in a holding device 16 which is constructed for optionally holding the metering apparatus 6 and a non-illustrated cartridge. In print jobs with a low ink consumption, the cartridge is inserted into the holding device 16 and, in print jobs having a high ink consumption, the metering apparatus 6 is inserted into the holding device 16.

The holding device 16 is attached to a slide 17 which can be displaced along a rail 18. The rail 18 extends parallel to a rotational axis of an ink fountain roll 19 which is assigned to the ink fountain 7. The metering apparatus 6, which is disposed above the ink fountain 7, meters the printing fluid 1, that is to say the printing ink, in the form of droplets or a jet, into the ink fountain 7 or onto the ink fountain roll 19. The movement of the holding device 16 is controlled by an electronic control device 3. Reference numerals 20, 21 and 22 denote control signals which the control device 3 receives and emits. A central machine controller 15 receiving the control signal 22 will be explained in more detail below.

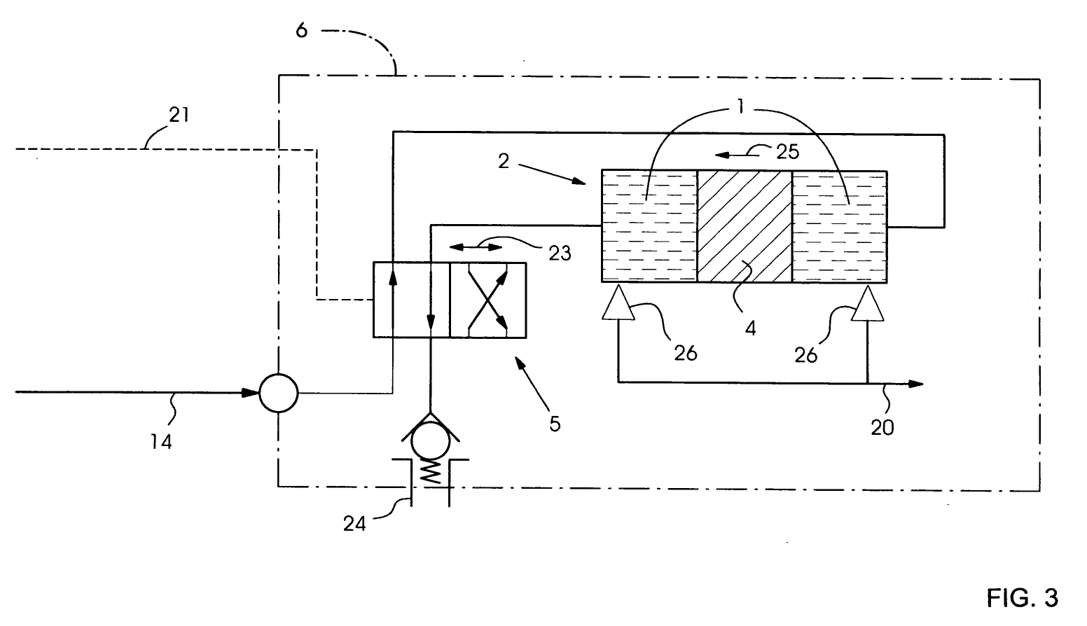

FIG. 3 shows the metering apparatus 6 in detail. It can be seen that the metering apparatus 6 includes a pump 2 and a multiway valve 5 for actuating the pump 2. The pump 2 is a piston pump, more accurately an axial piston pump, having a cylinder and a piston 4 which can be displaced in the cylinder. The control device 3 shown in FIG. 2 switches the multiway valve 5 with the control signal 21, optionally into a switching position which is set according to FIG. 3 and into another switching position, as is indicated symbolically by an arrow 23. As a result of the periodic switching of the multiway valve 5 back and forth, a pump chamber which lies in front of the piston 4 and a pump chamber which lies behind the piston 4 are connected alternately to the line system 14. These pump chambers are also connected alternately to an outlet 24.

In the switching position of the multiway valve 5 which is shown in FIG. 3, the pump chamber which lies in front of the piston 4 (that is the right-hand pump chamber in FIG. 3) is connected to the line system 14 and therefore to the supply device 9, with the result that the hydraulic pressure of the printing fluid 1, which hydraulic pressure is generated in the line system 14 by the delivery pump 11 (FIG. 1), acts on the right-hand (with regard to FIG. 3) side face of the piston 4 and displaces the latter in the direction which is specified by way of an arrow 25. As a result, the right-hand pump chamber is enlarged and it is filled with an increasing volume of the printing fluid 1. At the same time, the piston 4 displaces the printing fluid 1 out of the left-hand pump chamber which is connected in that switching position to the outlet 24, through the multiway valve 5, with the result that the printing fluid 1 passes out of the left-hand pump chamber in this way into the ink fountain 7 (FIG. 2).

The pump 2 is equipped with sensors 26 for detecting the two end positions of the piston 4. Each respective sensor 26 signals through the use of the control signal 20 of the control device 3 (FIG. 2) that the piston 4 has reached the respective end position. A signal is therefore sent to the control device 3 when the piston 4 has reached its left-hand (with regard to FIG. 3) end position. Proceeding from the control signal 20 of the corresponding sensor 26, the control device 3 switches the multiway valve 5 through the control signal 21 into its other switching position which is not shown in FIG. 3.

In this other switching position, the pump chamber which lies behind the piston 4 (that is the left-hand pump chamber with regard to FIG. 3) is connected to the supply device 9 and is loaded with the hydraulic pressure of the printing fluid 1 from the supply device 9. As a consequence, the piston 4 is then displaced in a direction opposite to the arrow 25, and the piston 4 displaces the printing fluid 1 which is taken in during the preceding work cycle in the pump chamber which lies in front of the piston 4 (that is the right-hand pump chamber with regard to FIG. 3), out of precisely this pump chamber and pumps it to the outlet 24. The end of this work cycle is detected by the other sensor 26 and signaled to the control device 3 which thereupon switches the multiway valve 5 again.

Through the use of the sensors 26, the control device 3 counts the number of strokes which the piston 4 performs in the direction which is specified by way of the arrow 25 and in the opposite direction. The number of strokes is proportional to the metering volume which passes into the ink fountain 7 through the outlet 24. The control device 3 informs the central machine controller 15 (FIG. 2) about this metering volume through the control signal 22. In this way, the machine controller 15 receives information about the ink consumption which is specific to a printing unit.

Since the operating volume of the pump 2 is known, the sensors 26 can be omitted and, instead, the control signals 21, through which the multiway valve 25 is switched, can be used directly for measuring the consumption of the printing fluid 1. In this case, the control device 3 counts the control signals 21, the number of which is proportional to the number of stroke movements of the piston 4 and therefore proportional to the overall amount of printing fluid 1 which is delivered into the ink fountain 7 as a consequence of these stroke movements.

It is important to note that the pump 2 not only delivers the printing fluid 1, but is driven itself by the printing fluid 1. This results in different advantages: no external energy, such as compressed air, is required to drive the pump 2. Moreover, uncomplicated measurement of the metered fluid volume is possible.

A further advantage is provided in the case of damage, in which the metering apparatus 6 of the first printing unit 12 is affected by a defect. In the case of damage, the delivery pump 11 can continue to run, in order to pump the printing fluid 1 to the metering apparatus 6 of the other, second printing unit 13, without there being a risk of the printing fluid 1 escaping from the metering apparatus 6 of the first printing unit 12 which is affected by the defect and causing subsequent damage in the first printing unit 12. A defect of this type could include, for example, a disruption of the control signal 21 or a blockage of the switching of the multiway valve 5. If a defect of this type occurs, the piston 4 only performs one more single stroke movement and the piston 4 remains in its end position which is reached by this stroke movement. Although the metering apparatus 6 which is affected by the defect continues to be loaded by the hydraulic pressure of the printing fluid 1, which pressure is generated by the supply device 9 that continues to run in order to supply the other printing press, there is no risk at all of the printing fluid 1 escaping from the metering apparatus 6 which is affected by the defect. The structurally imposed standstill of the piston 4 of the metering apparatus 6, which is affected by the defect in its end position, ensures that the pump 2 which includes this piston 4 does not pump an excess of the printing fluid 1 into the ink fountain 7, and that the latter cannot overflow. The pumping of the pump 2 stops automatically in the case of the defect.

If, instead of the metering apparatuses 6, the metering apparatuses which are described in the prior art according to German Published, Non-Prosecuted Patent Application DE 199 53 324 A1 were connected to the common supply device 9, there would then be the risk, in the event of a defect of one of those metering apparatuses, for example in the event of a defect of an outlet valve of that metering apparatus, of the printing ink escaping from the other metering apparatus which is not affected by the defect, if the common supply device 9 continued to run despite the defect. If the metering apparatuses of the prior art were used, it would therefore be necessary, if a defect of that type occurred, not only to bring that printing press to a standstill, the metering apparatus of which was affected by the defect, but also to bring the other printing presses to a standstill which were likewise supplied with the printing ink by the common supply device 9.

Unnecessary machine downtimes of that type are avoided by the use of the metering apparatus 6 according to the invention.

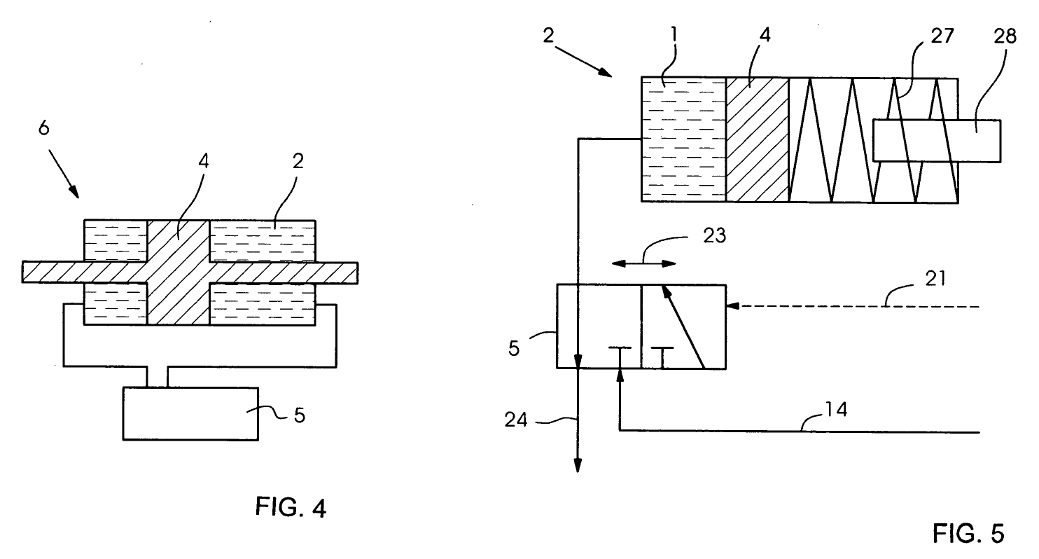

FIG. 4 shows one modification of the pump 2 which is shown in FIG. 3. While the piston 4 in the pump 2 which is shown in FIG. 3 is a piston without a piston rod, the piston 4 in the modification which is shown in FIG. 4 has two piston rods, the cross-sectional surface area of which is equally great, with the result that the pump 2 is configured as what is known as a synchronization cylinder. A synchronization cylinder of this type is a double-action hydraulic cylinder which operates in both piston movement directions with the same stroke force and the same stroke velocity. One advantage of the presence of the piston rods is to be seen in the fact that they guide the piston 4 and the latter can therefore have a simpler construction. In addition, a distance measuring system can be connected to the piston rods. Through the use of such a distance measuring system, the piston 4 can be displaced in an infinitely variable manner, with the result that infinitely variable precision metering of the printing fluid 1 is possible. Apart from the presence of the piston rods, the metering apparatus 6 which is shown in FIG. 4 corresponds completely in structural terms to the metering apparatus 6 which is shown in FIG. 3. Not all of the components are shown in FIG. 4 for reasons of improved clarity.

FIG. 5 shows a second exemplary embodiment which differs from the first exemplary embodiment of FIG. 3 only with regard to the construction of the pump 2 and the multiway valve 5. In the second exemplary embodiment, the piston 4 is loaded by a spring 27. When the multiway valve 5 is situated in its switching position which is shown in FIG. 5, the spring 27 displaces the piston 4 to the left in FIG. 5, with the result that the piston 4 pushes the printing fluid 1 out of the cylinder of the pump 2 and presses it to the outlet 24 through the multiway valve. When the multiway valve 5 is situated in its other switching position, the piston 4 is displaced to the right by the hydraulic pressure of the printing fluid 1 and counter to the restoring action of the spring 27, until the piston 4 comes into contact with a stop 28 which can be adjusted for limiting the piston travel and therefore the metering amount. In this case, the delivery pump 11 (FIG. 1) pumps the printing fluid 1 through the line system 14 and the multiway valve 5 into the cylinder of the pump 2, the expansion chamber of which is enlarged and again filled with the printing fluid 1. These two pump cycles, filling and emptying, are repeated as often as is necessary for the desired metering volume. In this case, the control device 3 (FIG. 2) counts the number of strokes of the piston 4, in order to determine the metering volume.

If any defect of the system occurs, the piston 4 performs at most one more stroke. Thereafter, the spring 27 holds the piston 4 firmly in its left-hand (in FIG. 5) end position, with the result that further running of the pump 2 and consequential overmetering of the printing fluid 1 are also avoided reliably in the second exemplary embodiment.

I claim:

1. A method for metering a printing fluid, the method comprising the following steps:
providing a pump; and
driving the pump with the printing fluid.

2. The method according to claim 1, which further comprises selecting the printing fluid from the group consisting of a printing ink and a varnish.

3. The method according to claim 1, wherein the pump is a piston pump.

4. The method according to claim 3, which further comprises:
providing the piston pump with a piston;
counting a number of strokes of the piston with a control device; and
determining a metering volume of the printing fluid from the number of the strokes, the number of the strokes being proportional to the metering volume.

5. The method according to claim 4, which further comprises loading the piston with the printing fluid through a multiway valve, controlling the multiway valve with the control device through control signals, and counting the control signals with the control device.

6. An apparatus for metering a printing fluid, the apparatus comprising:
a pump driven by the printing fluid.

7. The apparatus according to claim 6, wherein the printing fluid is a printing ink or a varnish.

8. The apparatus according to claim 6, wherein said pump is a piston pump.

9. The apparatus according to claim 8, wherein said piston pump has a piston, a control device counts a number of strokes of said piston, and said number of strokes is proportional to a metering volume of the printing fluid.

10. The apparatus according to claim 9, which further comprises a multiway valve for loading said piston with the printing fluid, said control device being configured for controlling said multiway valve through control signals and for counting said control signals.

11. A printing press, comprising a metering apparatus according to claim 6.

12. A system, comprising:
a first ink fountain;
a second ink fountain;
a common supply device for supplying said first ink fountain and said second ink fountain with printing fluid;
a metering apparatus according to claim 6 connecting said common supply device to said first ink fountain; and
a further metering apparatus according to claim 6 connecting said common supply device to said second ink fountain.

13. The system according to claim 12, wherein said common supply device includes a storage vessel for storing the printing fluid and a delivery pump for pumping the printing fluid.

14. The system according to claim 12, which further comprises a first printing press in which said first ink fountain is disposed, and a second printing press in which said second ink fountain is disposed.

15. A method for driving a pump, the method comprising the following steps:
driving the pump with a drive fluid; and
using a printing fluid as the drive fluid.

16. The method according to claim 15, wherein the pump is a piston pump.

17. The method according to claim 15, which further comprises selecting the printing fluid from the group consisting of a printing ink and a varnish.
